(19) United States
(12) Patent Application Publication
(10) Pub. No.: US 2025/0216081 A1
(43) Pub. Date: Jul. 3, 2025

(54) COMBUSTOR WITH ADJUSTABLE AIR FLOW FOR AXIAL FUEL STAGE INJECTOR AND HEAD END FUEL NOZZLE ASSEMBLY

(71) Applicant: GE Infrastructure Technology LLC, Greenville, SC (US)

(72) Inventor: Richard Martin DiCintio, Simpsonville, SC (US)

(21) Appl. No.: 18/399,849

(22) Filed: Dec. 29, 2023

(51) Int. Cl. F23R 3/28; F02C 7/12; F02C 7/22

(52) U.S. Cl. CPC F23R 3/283; F02C 7/12; F02C 7/22; F05D 2260/20

(57) ABSTRACT

A combustor for a gas turbine system includes a combustor body, a head end fuel nozzle assembly, and an axial fuel stage (AFS) injector. An air flow passage defined at least partially by the combustor body is configured to deliver a first portion of an air supply to the head end fuel nozzle assembly, and the AFS injector is configured to receive a second portion of the air supply. A valve is operatively positioned between the air supply and the AFS injector. With the AFS injector on (i.e., fueled), the valve is open, and a third, additional portion of the air supply flows to the AFS injector. With the AFS injector off (i.e., unfueled), the valve is closed to block the third portion flowing to the AFS injector and to deliver it to the head end fuel nozzle assembly, which reduces the firing temperature for highly reactive fuels.

### TECHNICAL FIELD

The disclosure relates generally to turbomachine combustors and, more specifically, to a combustor including a valve to direct an additional portion of an air supply to an axial fuel stage (AFS) injector or a head end fuel nozzle assembly depending on whether the AFS injector is operating to deliver fuel to the combustor.

### BACKGROUND

Gas turbine systems include a combustion section including a plurality of combustors in which fuel is combusted to create a flow of combustion gas that is converted to kinetic energy in a downstream turbine section. Current combustors include a head end fuel nozzle assembly for combusting fuel in a primary combustion zone and axial fuel stage (AFS) injectors for combusting fuel in a secondary combustion zone downstream of the primary combustion zone. Portions of an air supply, for example, from a compressor discharge, are delivered to the head end fuel nozzle assembly and the AFS injectors in various flow passages. The flow passages and the openings thereto are fixed. Hence, the air split between the head end fuel nozzle assembly and the AFS injectors is also fixed. The fixed nature of the air split presents challenges for the combustors to handle different fuels, such as fuels that are highly reactive or that cannot be easily routed to the AFS injectors. Liquid fuels, such as diesel fuels, are one type of fuel that presents challenges to use in the AFS injectors.

### BRIEF DESCRIPTION

All aspects, examples and features mentioned below can be combined in any technically possible way.

An aspect of the disclosure includes a combustor for a gas turbine system, the combustor comprising: a combustor body; a head end fuel nozzle assembly at a forward end of the combustor body; an air flow passage defined at least partially by the combustor body, the air flow passage configured to deliver a first portion of an air supply to the head end fuel nozzle assembly; an axial fuel stage (AFS) injector directed into the combustor body downstream of the head end fuel nozzle assembly, the AFS injector configured to receive a second portion of the air supply; and a valve operatively positioned between the air supply and the AFS injector, wherein, in an open position, the valve flows a third, additional portion of the air supply to the AFS injector and, in a closed position, the valve blocks the third, additional portion of the air supply from flowing to the AFS injector.

Another aspect of the disclosure includes any of the preceding aspects, and in response to the AFS injector operating, the valve is in the open position with the third, additional portion of the air supply flowing to the AFS injector; and in response to the AFS injector being inoperative, the valve is in the closed position, blocking the third, additional portion of the air supply from flowing to the AFS injector and causing the third, additional portion of the air supply to enter the air flow passage to the head end fuel nozzle assembly.

Another aspect of the disclosure includes any of the preceding aspects, and the air supply includes a compressor discharge, and wherein the first portion of the air supply is pulled directly from the compressor discharge and the second portion of the air supply passes through cooling passage defined in a hot part of the combustor after being pulled from the compressor discharge.

Another aspect of the disclosure includes any of the preceding aspects, and the hot part includes at least one of a tapered transition portion of the combustor body and an aft frame at an aft end of the tapered transition portion of the combustor body.

Another aspect of the disclosure includes any of the preceding aspects, and the cooling passage is between the AFS injector and the air supply, and the cooling passage configured to deliver the second portion of the air supply to the AFS injector.

Another aspect of the disclosure includes any of the preceding aspects, and the cooling passage is defined at least partially in a tapered transition portion of the combustor body or between the tapered transition portion of the combustor body and a flow sleeve spaced along at least a portion of an exterior surface of the tapered transition portion of the combustor body.

Another aspect of the disclosure includes any of the preceding aspects, and the AFS injector includes a plurality of AFS injectors positioned about the combustor body, and the valve includes a plurality of valves.

Another aspect of the disclosure includes any of the preceding aspects, and the valve includes one or more of: an electrically controlled valve controlled by a combustor controller that controls operation of the combustor, a temperature sensitive control valve configured to close based on a temperature in the combustor body, or a pressure sensitive control valve configured to close based on a pressure in the combustor body.

Another aspect of the disclosure includes any of the preceding aspects, and the combustor body is additively manufactured (AM) and includes a plurality of parallel, sintered metal layers.

Another aspect of the disclosure includes any of the preceding aspects, and the combustor body includes: a combustion liner including a cylindrical portion and a tapered transition portion, wherein the air flow passage is defined at least partially by the cylindrical portion of the combustion liner; an axial fuel stage (AFS) injector opening directed into the combustion liner downstream of the head end fuel nozzle assembly, the AFS injector opening configured to have the AFS injector mounted thereto and to receive the second portion of the air supply; and a valve opening operatively positioned between the air supply and the AFS injector opening, the valve opening configured to mount the valve; wherein, in the open position of the valve, the third, additional portion of the air supply flows through the valve opening to the AFS injector opening and, in the closed position of the valve, the third, additional portion of the air supply is blocked from flowing to the AFS injector opening; and wherein the air flow passage is defined at least partially by the cylindrical portion of the combustion liner.

Another aspect of the disclosure includes a combustor body for a combustor for a gas turbine system, the combustor body comprising: a combustion liner including a cylindrical portion and a tapered transition portion; an air flow passage defined at least partially by the cylindrical portion of the combustion liner, the air flow passage configured to deliver a first portion of an air supply to a head end fuel nozzle assembly at a forward end of the combustion liner; an axial fuel stage (AFS) injector opening directed into the combustion liner downstream of the head end fuel nozzle assembly, the AFS injector opening configured to have an AFS injector mounted thereto and to receive a second portion of the air supply; and a valve opening operatively positioned between the air supply and the AFS injector opening, the valve opening configured to mount a valve thereto.

Another aspect of the disclosure includes a gas turbine (GT) system, comprising: a compressor section; a combustion section operatively coupled to the compressor section; and a turbine section operatively coupled to the combustion section, wherein the combustion section includes at least one combustor including: a combustor body; a head end fuel nozzle assembly at a forward end of the combustor body; an air flow passage defined at least partially by the combustor body, the air flow passage configured to deliver a first portion of an air supply to the head end fuel nozzle assembly; an axial fuel stage (AFS) injector directed into the combustor body downstream of the head end fuel nozzle assembly, the AFS injector configured to receive a second portion of the air supply; and a valve operatively positioned between the air supply and the AFS injector, wherein, in an open position, the valve flows a third, additional portion of the air supply to the AFS injector and, in a closed position, the valve blocks the third, additional portion of the air supply from flowing to the AFS injector.

Another aspect of the disclosure includes any of the preceding aspects, and in response to the AFS injector operating, the valve is in the open position with the third, additional portion of the air supply flowing to the AFS injector; and in response to the AFS injector being inoperative, the valve is in the closed position, blocking the third, additional portion of the air supply from flowing to the AFS injector and causing the third, additional portion of the air supply to enter the air flow passage to the head end fuel nozzle assembly.

Another aspect of the disclosure includes any of the preceding aspects, and the air supply includes a compressor discharge of the compressor section, and wherein the first portion of the air supply is pulled directly from the compressor discharge and the second portion of the air supply passes through cooling passage defined in a hot part of the combustor after being pulled from the compressor discharge.

Another aspect of the disclosure includes any of the preceding aspects, and the cooling passage is between the AFS injector and the air supply, and the cooling passage is configured to deliver the second portion of the air supply to the AFS injector.

Another aspect of the disclosure includes any of the preceding aspects, and the cooling passage is defined at least partially in at least one of: a tapered transition portion of the combustor body or between the tapered transition portion of the combustor body and a flow sleeve spaced along at least a portion of an exterior surface of the tapered transition portion of the combustor body; and an aft frame at an aft end of the tapered transition portion.

Another aspect of the disclosure includes any of the preceding aspects, and the combustor body includes: a combustion liner including a cylindrical portion and a tapered transition portion, wherein the air flow passage is defined at least partially by the cylindrical portion of the combustion liner; an axial fuel stage (AFS) injector opening directed into the combustion liner downstream of the head end fuel nozzle assembly, the AFS injector opening configured to have the AFS injector mounted thereto and to receive the second portion of the air supply; and a valve opening operatively positioned between the air supply and the AFS injector opening, the valve opening configured to mount the valve; wherein, in the open position of the valve, the third, additional portion of the air supply flows through the valve opening to the AFS injector opening and, in the closed position of the valve, the third, additional portion of the air supply is blocked from flowing to the AFS injector opening; and wherein the air flow passage is defined at least partially by the cylindrical portion of the combustion liner.

Another aspect of the disclosure includes a method of operating a combustor for a gas turbine system, the combustor including a head end fuel nozzle assembly for first combusting a first fuel in a primary combustion zone in a combustor body and an axial fuel stage (AFS) injector for selectively, second combusting a second fuel in a second combustion zone in the combustor body, the method comprising: in a first setting, during a period in which both the first combusting and the second combusting occur, delivering a first pre-cooling portion of an air supply to the head end fuel nozzle assembly, a second post-cooling portion of the air supply to the AFS injector and a third, additional pre-cooling portion of the air supply to the AFS injector; and in a second setting, during a period in which the first combusting is occurring and the second combusting is not occurring, delivering the first pre-cooling portion of the air supply to the head end fuel nozzle assembly, the second post-cooling portion of the air supply to the AFS injector, and the third, additional pre-cooling portion of the air supply to the head end fuel nozzle assembly.

Another aspect of the disclosure includes any of the preceding aspects, and the delivering of the third, additional pre-cooling portion of the air supply includes controlling a valve operatively positioned between the air supply and the AFS injector.

Another aspect of the disclosure includes any of the preceding aspects, and, in the first setting, the head end fuel nozzle assembly receives between 40 to 80% of the air supply, and the AFS injector receives between 20 to 60% of the air supply; and wherein, in the second setting, the head end fuel nozzle assembly receives between 75 to 95% of the air supply, and the AFS injector receives between 5 to 25% of the air supply.

Another aspect of the disclosure includes any of the preceding aspects, and further comprising passing the second, post-cooling portion of the air supply through a cooling passage in at least one hot part of the combustor prior to delivering the second, post-cooling portion of the air supply to the AFS injector.

Two or more aspects described in this disclosure, including those described in this summary section, may be combined to form implementations not specifically described herein. That is, all embodiments described herein can be combined with each other.

The details of one or more implementations are set forth in the accompanying drawings and the description below. Other features, objects and advantages will be apparent from the description and drawings, and from the claims.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a functional block diagram of an illustrative gas turbine system capable of use with a combustor according to embodiments of the disclosure;

FIG. 2 shows a cross-sectional side view of a combustor according to embodiments of the disclosure;

FIG. 3 shows a cross-sectional perspective view of a combustor according to embodiments of the disclosure;

FIG. 4 shows an end perspective view of a combustor according to embodiments of the disclosure;

FIG. 5 shows an enlarged perspective view of a valve for a combustor body according to embodiments of the disclosure;

FIG. 6 shows an enlarged perspective view of a valve for a combustor body according to other embodiments of the disclosure;

FIG. 7A shows a cross-sectional side view of the valve for the combustor in a closed position according to embodiments of the disclosure;

FIG. 7B shows a cross-sectional side view of the valve for the combustor in an open position according to embodiments of the disclosure;

FIG. 8 shows a cross-sectional view of a plurality of parallel, sintered metal layers of the combustor body according to embodiments of the disclosure; and

FIG. 9 shows a schematic block diagram of an illustrative additive manufacturing system for additively manufacturing a combustor body according to embodiments of the disclosure.

It is noted that the drawings of the disclosure are not necessarily to scale. The drawings are intended to depict only typical aspects of the disclosure and therefore should not be considered as limiting the scope of the disclosure. In the drawings, like numbering represents like elements between the drawings.

### DETAILED DESCRIPTION

As an initial matter, in order to clearly describe the current disclosure, it will become necessary to select certain terminology when referring to and describing relevant machine components within the illustrative application of a turbomachine. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

In addition, several descriptive terms may be used regularly herein, and it should prove helpful to define these terms at the onset of this section. These terms and their definitions, unless stated otherwise, are as follows. As used herein, “downstream” and “upstream” are terms that indicate a direction relative to the flow of a fluid, such as the working fluid through a combustor of the turbomachine or, for example, the flow of air through the combustor or coolant through one of the turbomachine's component systems. The term “downstream” corresponds to the direction of flow of the fluid, and the term “upstream” refers to the direction opposite to the flow. The terms “forward” and “aft,” without any further specificity, refer to directions, with “forward” referring to the front or compressor end of the turbomachine, and “aft” referring to the rearward or turbine end of the turbomachine.

The term “axial” refers to movement or position parallel to an axis, e.g., an axis of a combustor or turbomachine. The term “radial” refers to movement or position perpendicular to an axis, e.g., an axis of a combustor or a turbomachine. In cases such as this, if a first component resides closer to the axis than a second component, it will be stated herein that the first component is “radially inward” or “inboard” of the second component. If, on the other hand, the first component resides further from the axis than the second component, it may be stated herein that the first component is “radially outward” or “outboard” of the second component. Finally, the term “circumferential” refers to movement or position around an axis, e.g., a circumferential interior surface of a combustor body or a circumferential interior of casing extending about a combustor. As indicated above and depending on context, it will be appreciated that such terms may be applied in relation to the axis of the combustor or the axis of the turbomachine.

In addition, several descriptive terms may be used regularly herein, as described below. The terms “first,” “second,” and “third,” may be used interchangeably to distinguish one component from another and are not intended to signify location or importance of the individual components.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event may or may not occur or that the subsequently described feature may or may not be present and that the description includes instances where the event occurs, or the feature is present and instances where the event does not occur, or the feature is not present.

Where an element or layer is referred to as being “on,” “engaged to,” “connected to,” “coupled to,” or “mounted to” another element or layer, it may be directly on, engaged, connected, coupled, or mounted to the other element or layer, or intervening elements or layers may be present. In contrast, when an element is referred to as being “directly on,” “directly engaged to,” “directly connected to,” “directly coupled to,” or “directly mounted to” another element or layer, there are no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The verb forms of “couple” and “mount” may be used interchangeably herein.

Embodiments of the disclosure provide a combustor for a gas turbine system. The combustor includes a combustor body, a head end fuel nozzle assembly, and an axial fuel stage (AFS) injector. An air flow passage, defined at least partially by the combustor body, is configured to deliver a first portion of an air supply to the head end fuel nozzle assembly, and the AFS injector is configured to receive a second portion of the air supply. A valve is operatively positioned between the air supply and the AFS injector. With the AFS injector on (i.e., fueled), the valve is open and flows a third, additional portion of the air supply to the AFS injector, and with the AFS injector off (i.e., unfueled), the valve is closed to block the third portion of the air supply from flowing to the AFS injector such that it is delivered to the head end fuel nozzle assembly.

Hence, when the AFS injector is off, the valve provides additional air supply to the head end fuel nozzle assembly to increase air volume and velocity so higher reactive fuels (e.g., liquid fuels or hydrogen) can be used therein. The additional air also advantageously reduces the firing temperature of the head end fuel nozzle assembly (providing flame holding benefits) for highly reactive fuels. During this setting, the second portion of the air supply is sufficient to continue to cool hot parts aft of the AFS injectors (i.e., downstream relative to the flow of combustion gases), such as a tapered transition portion of the combustor body or an aft frame at an aft end of the transition portion. When the AFS injector is on, the valve opens to deliver the additional air volume and velocity to the AFS injector(s), i.e., during full operation of the combustor. The combustor body may be additively manufactured to include a plurality of parallel, sintered metal layers.

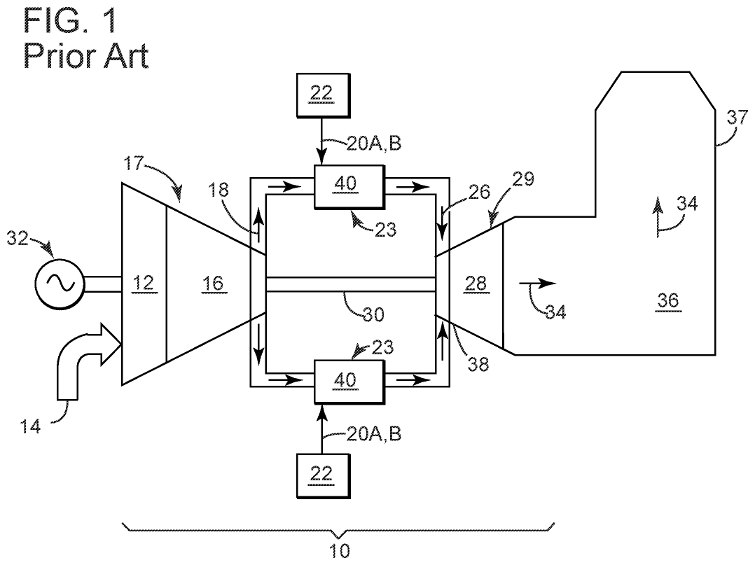

FIG. 1 shows a functional block diagram of an illustrative gas turbine (GT) system 10 that may incorporate various embodiments of a combustor 40 of the present disclosure. As shown, GT system 10 generally includes an inlet section 12 that may include a series of filters, cooling coils, moisture separators, and/or other devices to purify and otherwise condition a working fluid (e.g., air) 14 entering GT system 10. Working fluid 14 flows to a compressor 16 in a compressor section 17 that progressively imparts kinetic energy to working fluid 14 to produce a compressed air 18 (hereafter “air 18” or “compressed air 18”) at a highly energized state. Compressed air 18 is mixed with a fuel 20A and/or 20B from at least one fuel supply 22 to form a combustible mixture within at least one combustor 40 in a combustion section 23 that is operatively coupled to compressor section 17. The combustible mixture is burned to produce combustion gases 26 having a high temperature and pressure.

Combustion gases 26 flow through a turbine 28 (e.g., an expansion turbine) of a turbine section 29 operatively coupled to combustion section 23 to produce work. For example, turbine 28 may be connected to a shaft 30 so that rotation of turbine 28 drives compressor 16 to produce compressed air 18. Alternately, or in addition, shaft 30 may connect turbine 28 to a generator 32 for producing electricity. Exhaust gases 34 from turbine 28 flow through an exhaust section 36 that connects turbine 28 to an exhaust stack 37 downstream from turbine 28. Exhaust section 36 may include, for example, a heat recovery steam generator (not shown) for cleaning and extracting additional heat from exhaust gases 34 prior to release to the environment. Where more than one combustor 40 is used, they may be circumferentially spaced around a turbine inlet 144 of turbine 28.

In one embodiment, GT system 10 may include a current engine model, commercially available from GE Vernova of Cambridge, MA. The present disclosure is not limited to any one particular GT system and may be implanted in connection with other engines including, for example, the other HA, F, B, LM, GT, TM and E-class engine models of GE Vernova, and engine models of other companies. Furthermore, the present disclosure is not limited to any particular turbomachine and may be applicable to, for example, steam turbines, jet engines, compressors, turbofans, etc.

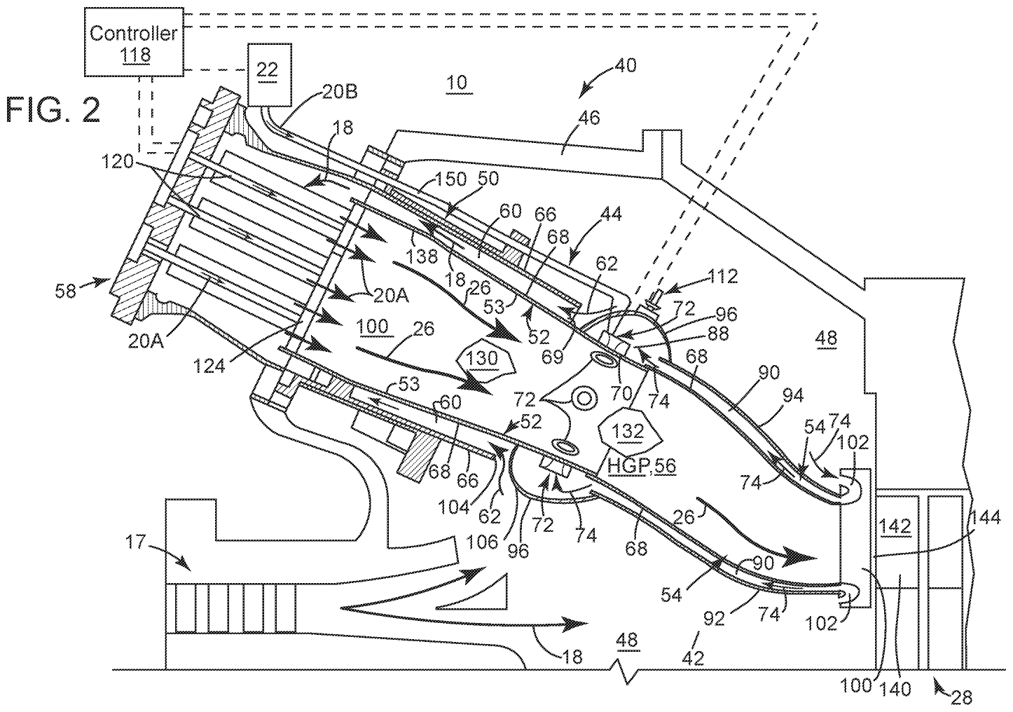

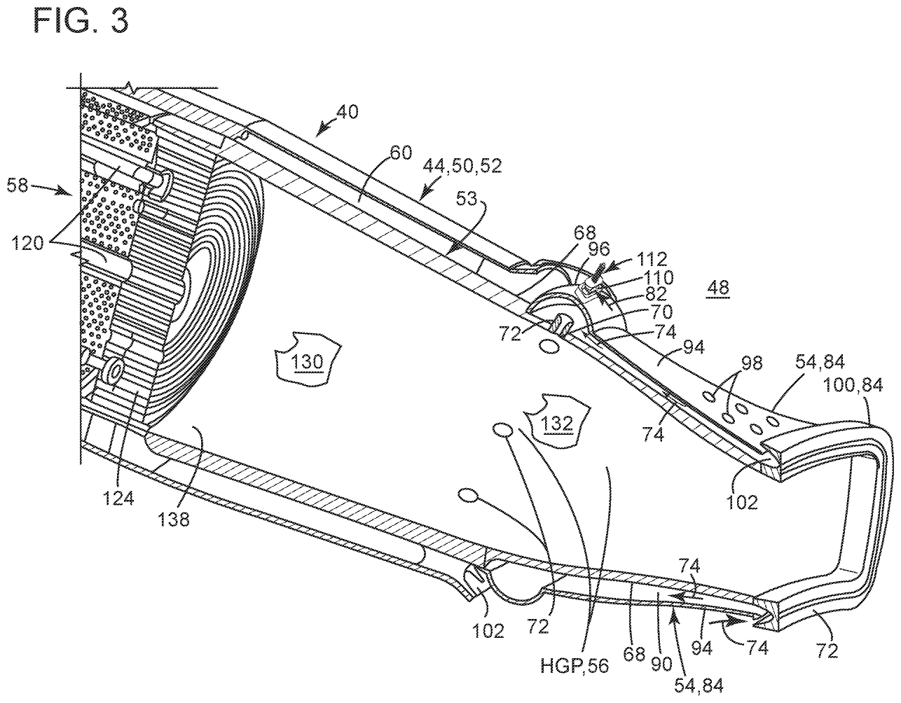

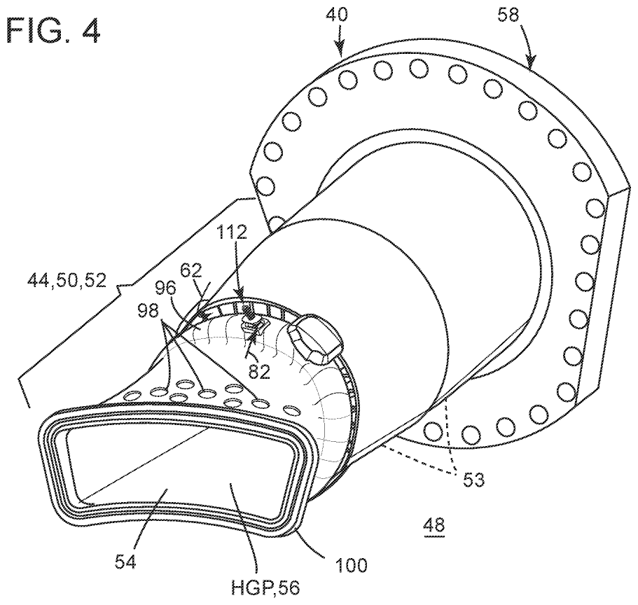

A combustor 40 usable within GT system 10 will now be described. FIG. 2 shows a cross-sectional side view of combustor 40 positioned within GT system 10; FIG. 3 shows a partial cross-sectional view of a combustor body 44 of combustor 40; and FIG. 4 shows an end perspective view of combustor body 44.

As shown in FIG. 2, combustor 40 is at least partially surrounded by an outer casing 46 such as a compressor discharge casing and/or a turbine casing. An interior of outer casing 46 is in fluid communication with a compressor discharge of compressor 16 and creates an air supply 48. That is, air supply 48 includes compressed air 18 from compressor discharge of compressor 16. However, air supply 48 may be any supply of compressed air 18 capable of flowing into any variety of opening or flow passage in combustor 40 to cool parts and/or for combustion.

As shown in FIGS. 2-4, combustor 40 for GT system 10 includes a combustor body 44. Combustor body 44 may be made using any now known or later developed techniques. As will be further described, in certain embodiments, combustor body 44 may be additively manufactured and include a one-piece member 50. In any event, combustor body 44 includes a combustion liner 52 including a cylindrical portion 53 and a tapered transition portion 54. Tapered transition portion 54 is at an aft end (right side as shown in FIGS. 2 and 3) of cylindrical portion 53. Tapered transition portion 54 transitions the hot gas path (HGP) from the liner's cylindrical portion 53 circular cross-section to a more arcuate cross-section for mating with turbine inlet 144 of turbine 28. Combustor 40 may also include an aft frame 100 at an aft end (right side in FIGS. 2-3) of tapered transition portion 54.

Combustion liner 52 may contain and convey combustion gases 26 to turbine section 29. More particularly, combustion liner 52 defines a combustion chamber 56, i.e., in a hot gas path (HGP), within which combustion occurs. As shown in FIG. 2, combustion liner 52 may have tapered transition portion 54 that is separate from cylindrical portion 53, as in many conventional combustion systems. Alternately, as shown in FIGS. 3 and 4, combustion liner 52 may have a unified body (or “unibody”) construction, in which cylindrical portion 53 and tapered transition portion 54 are integrated with one another, i.e., as part of additively manufactured one-piece member 50. Thus, any discussion of combustion liner 52 herein is intended to encompass both conventional combustion systems having a separate cylindrical and tapered transition portions 53, 54 and those combustion systems having a unibody liner.

Combustor body 44 also includes an air flow passage 60 defined at least partially by cylindrical portion 53 of combustion liner 52. As will be described herein, air flow passage 60 is configured to deliver a first portion 62 of air supply 48 to a head end fuel nozzle assembly 58 (hereinafter “head end assembly 58” for brevity) of combustor 40 at a forward end (left end in FIG. 2) of combustion liner 52. That is, it is sized, shaped and/or arranged to deliver first portion 62 of air supply 48 to head end assembly 58 of combustor 40. In certain embodiments, as shown in FIG. 2, air flow passage 60 may be provided between a first flow sleeve 66 spaced along at least a portion of an exterior surface 68 of cylindrical portion 53. Air flow passage 60 has an open end 69 upstream (forward) of AFS injector(s) 72 (described herein) through which first portion 62 of air supply 48 enters. First portion 62 of air supply 48 may be pulled directly from compressor discharge, i.e., without any other use of the air other than coincidental convection cooling of combustor body 44. First portion 62 of air supply 48 may also be referred to herein as a “pre-cooling” portion of air supply 48 since it is used prior to it providing any significant cooling of parts of combustor 40. In other embodiments, as shown in FIG. 3, where combustor body 44 is additively manufactured, air flow passage 60 may be defined wholly within cylindrical portion 53 (i.e., between an inner cylindrical structure defining a liner and an outer cylindrical structure defining a flow sleeve).

Combustor body 44 also includes an axial fuel stage (AFS) injector opening or seat 70 directed into combustion liner 52 downstream of head end assembly 58. Opening or seat 70 extends through a wall of combustion liner 52. One or more AFS injector openings or seats 70 (hereafter “openings 70”) can be provided and are configured to have an AFS injector 72 mounted thereto and receive a second portion 74 of air supply 48 through a cooling passage 90. Each AFS injector opening 70 may include any necessary structure to allow an AFS injector 72 to be mounted thereto, e.g., threaded fasteners, bolt holes, weld area, etc. AFS injector(s) 72 are configured to receive second portion 74 of air supply 48 through cooling passage 90 and direct it with second fuel 20B into combustion liner 52. As illustrated, combustor 40 and combustor body 44 may include a plurality of circumferentially spaced AFS injector openings 70 and corresponding AFS injectors 72. Any number of AFS injectors 72 can be used.

Second portion 74 of air supply 48 can be delivered to AFS injector(s) 72 in a variety of ways. In certain embodiments, second portion 74 of air supply 48 may be pulled directly from air supply 48, i.e., without being used for any cooling. In accordance with embodiments of the disclosure, however, second portion 74 of air supply 48 is preferably used for cooling prior to use in AFS injector(s) 72. In this case, combustor body 44 further includes a cooling passage 90 at least partially defined by tapered transition portion 54. As will be described, cooling passage 90 may be in fluid communication with other cooling passages in combustor 40. Second portion 74 of air supply 48 may be used for cooling one or more hot parts 84 of combustor 40. More particularly, second portion 74 of air supply 48 passes through cooling passage(s) 90, 102, which as noted is at least partially defined by tapered transition portion 54, after being pulled from compressor discharge. The cooling passage(s) may also be partially defined in (another) hot part(s) 84 of combustor 40 other than tapered transition portion 54. In any event, the cooling passage(s) extend between AFS injector(s) 72 and air supply 48 with the cooling passage(s) configured to deliver second portion 74 of air supply 48 to AFS injector(s) 72. Second portion 74 of air supply 48 may also be referred to herein as a “post-cooling” portion of air supply 48 since it is used to provide significant cooling of parts of combustor 40.

Hot parts 84 may include any parts of combustor 40 through which cooling is desired and cooling passage(s) may be directed. The cooling passage(s) extend between AFS injector(s) 72 and air supply 48 and is/are configured to deliver second (post-cooling) portion 74 of air supply 48 to AFS injector(s) 72. For example, as shown in FIGS. 2-3, combustor body 44 of combustor 40 may include one or more cooling passages 90 for delivering second portion 74 of air supply 48. In certain embodiments, cooling passage(s) 90 may be provided at least partially within tapered transition portion 54 of combustion liner 52, i.e., so that second portion 74 of air supply 48 cools tapered transition portion 54. Cooling passage 90 for tapered transition portion 54 can take a variety of forms. In certain embodiments, as shown in FIG. 2, cooling passage 90 may be defined between tapered transition portion 54 of combustion body 44 and a (second) flow sleeve 92 spaced along at least a portion of exterior surface 68 of tapered transition portion 54 of combustion body 44. Alternately, as shown in FIG. 3, cooling passage 90 may be defined wholly within tapered transition portion 54, e.g., additively manufactured between an inner transition portion wall and an outer transition portion wall.

In certain embodiments, cooling passage(s) 90 includes a single portion 94 spaced from and parallel to at least a portion of exterior surface 68 of transition portion 54. In other embodiments, as shown in FIGS. 2-4, cooling passage(s) 90 include a first portion 94 spaced from and parallel to at least a portion of exterior surface 68 of transition portion 54 and a second portion 96 extending in an outwardly convex manner over an air inlet of AFS injector(s) 72. First or single portion 94 can have any shape that generally parallels the contours of transition portion 54 over which it extends. First portion 94 can be spaced from exterior surface 68 of transition portion 54 in any manner (e.g., bosses, internal cooling passage fin structure, stand-offs, etc.) that does not impede air 18 flow through cooling passage(s) 90. Second portion 96 (where provided), as shown in FIGS. 2-4, may have any shape configured to collect air as part of cooling passage(s) 90 and deliver it to the air inlets of one or more AFS injector(s) 72. In any event, second portion 74 of air supply 48 from cooling passage(s) 90 is directed to air inlet(s) of AFS injector(s) 72. (Note, the air inlet(s) (not shown) can be in one or more of circumferential side(s) and/or radial outer surface of AFS injector(s) 72.) As shown in FIG. 2, aft frame 100 may include another one or more cooling passages 102 therein that receive compressed air 18 from air supply 48 for cooling (creating second portion 74 of air supply 48). Aft frame 100 may direct (i.e., outlet) second portion 74 of air supply 48 to cooling passage(s) 90 for delivery to AFS injector(s) 72.

Hot part(s) 84 may include any part of combustor 40 requiring cooling, and second (post-cooling) portion 74 of air supply 48 may be directed to enter the cooling passage(s) in any manner desired. For example, as shown in FIGS. 2-6, one hot part 84 may include tapered transition portion 54 of combustion liner 52 of combustor body 44. Here, as shown in FIG. 3, second portion 74 of air supply 48 may enter cooling passage(s) 90 by holes 98 in first portion 94, e.g., impingement holes defined in a radially outer part of tapered transition portion 54 or in second flow sleeve 92 (FIG. 2). In other embodiments, hot part 84 may include tapered transition portion 54 and aft frame 100 of combustion liner 52 of combustor body 44. As noted, and as shown in FIGS. 2 and 3, aft frame 100 may include other cooling passage(s) 102 therein that receive second portion 74 of air supply 48 and outlets it to cooling passage(s) 90. Hence, hot part 84 may include at least one of tapered transition portion 54 of combustor body 44 and aft frame 100 at an aft end of tapered transition portion 54 of combustor body 44. (Note, aft frame 100 may be integral with tapered transition portion 54, e.g., through collective additive manufacturing, or connected to tapered transition portion 54, e.g., through welding or other connection mechanisms.) As will be recognized by those with skill in the art, a variety of alternative hot parts 84 are possible.

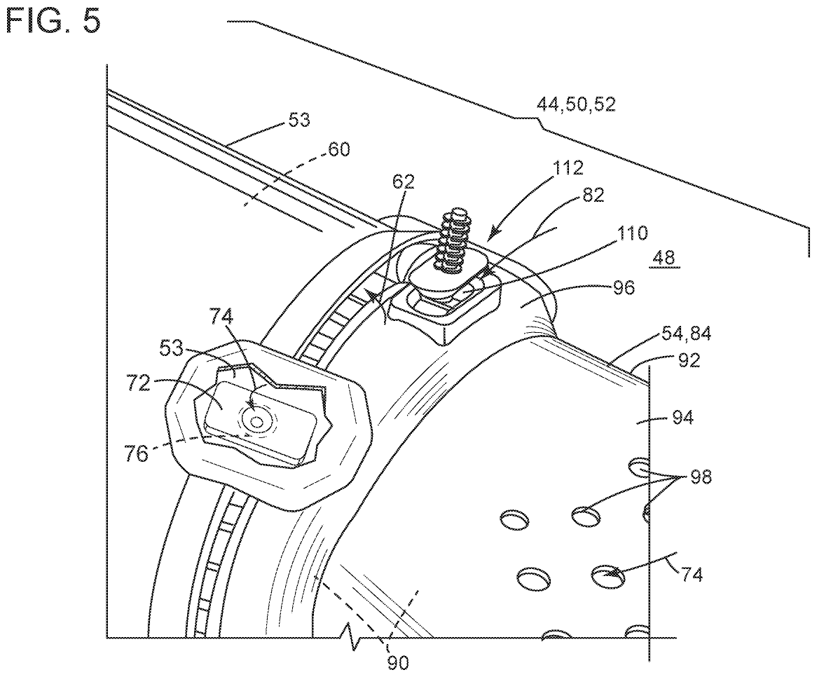

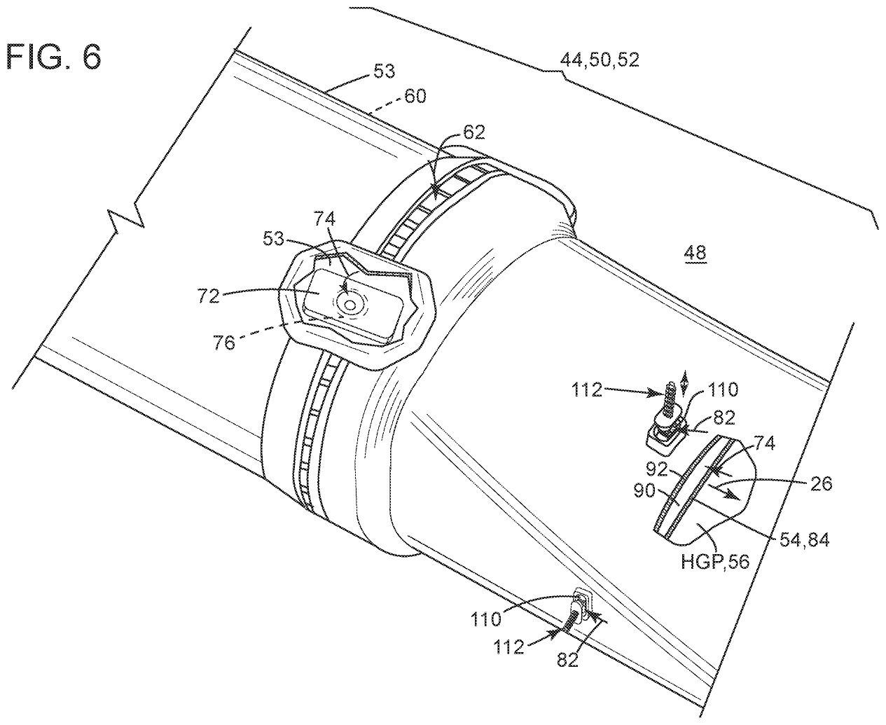

FIG. 5 shows an enlarged perspective view of a valve 112 for combustor body 44 of combustor 40 according to embodiments of the disclosure; and FIG. 6 shows an enlarged perspective view of valve 112 for combustor body 44 according to other embodiments of the disclosure. In contrast to current combustors, the present combustor body 44, as shown in FIGS. 2-6, also includes a valve opening 110 to cooling passage 90. Valve opening 110 is operatively positioned between air supply 48 and AFS injector opening 70. Valve opening 110 may fluidly couple, for example, air supply 48 directly to AFS injector openings 70 or to any portion of cooling passage(s) 90. Valve opening 110 is configured to mount a valve 112 thereto and receive an additional portion 82 of air supply 48, i.e., pre-cooling air from air supply 48. Valve opening 110 may include any necessary structure to allow valve 112 to be mounted thereto, e.g., threaded fasteners, bolt holes, weld area, etc.

Additional portion 82 may be referred to herein as an “additional portion” 82 of air supply 48 and may be considered another “pre-cooling” portion of air supply 48 since it is used prior to it providing any significant cooling of parts of combustor 40. Valve opening 110 and valve 112 can be positioned in any location relative to cooling passage 90 so that additional portion 82 of air supply 48 can be pulled directly from air supply 48, i.e., without it being used for cooling other than coincidental cooling of combustor body 44. In FIGS. 2-5, valve opening 110 is in second portion 96 of cooling passage 90, and in FIG. 6, valve opening 110 is in first portion 94 of cooling passage 90, e.g., in second flow sleeve 92 (where provided and as shown) or in tapered transition portion 54 (where cooling passage(s) 90 is/are integrally formed therein).

Referring to FIGS. 2-6, collectively, a combustor 40 for GT system 10 that uses combustor body 44 with valve 112 will now be described in more detail. Combustor 40 includes combustor body 44, as described herein. Combustor body 44 with valve 112 may be used in a new combustor or retrofitted into a used combustor. Combustor 40 also includes head end assembly 58 at forward end 138 of combustor body 44, as described herein. Head end assembly 58 generally includes at least one axially extending fuel nozzle 120 that extends downstream from an end cover 122 to cap assembly 124 that extends radially and axially within combustion liner 52 downstream from end cover 122 and that defines the upstream boundary of the combustion chamber. Head end assembly 58 may include any now known or later developed axially extending fuel nozzles 120 for delivering first fuel 20A to a primary combustion zone 130 from axially extending fuel nozzles 120. In certain embodiments, axially extending fuel nozzle(s) 120 of head end assembly 58 extend at least partially through cap assembly 124 to provide a combustible mixture of fuel and compressed air 18 to primary combustion zone 130.

Combustor 40 also includes air flow passage 60 defined at least partially by combustor body 44 and, more particularly, cylindrical portion 53 of combustion liner 52. In some embodiments, air flow passage 60 is defined between cylindrical portion 53 of combustion liner 52 and first flow sleeve 66. Air flow passage 60 is configured to deliver first portion 62 of air supply 48, i.e., compressed air 18, to head end assembly 58. More particularly, air flow passage 60 is dimensioned and/or shaped to deliver first portion 62 of air supply 48 to head end assembly 58. As will be described, air flow passage 60 may also deliver additional portion 82 of air supply 48 through valve 112 to head end assembly 58. First portion 62 of air supply 48 and, where provided, additional portion 82 of air supply 48, is/are combined with first fuel 20A and combusted in primary combustion zone 130.

Combustor 40 also includes at least one axial fuel stage (AFS) injector 72 directed into combustor body 44, i.e., combustion liner 52. As noted, AFS injector 72 may include a plurality of AFS injectors 72 circumferentially spaced around combustion body 44. Each AFS injector 72 extends radially through combustion liner 52 downstream from head end assembly 58, i.e., axially extending fuel nozzle(s) 120. AFS injectors 72 are configured to receive second portion 74 of air supply 48. More particularly, second (post-cooling) portion 74 of air supply 48 may be routed to AFS injector(s) 72, e.g., in cooling passage(s) 90, to combine with second fuel 20B for combustion in a secondary combustion zone 132 that is downstream from primary combustion zone 130. As will be described, in some settings, additional portion 82 of air supply 48 may also be directed to AFS injector(s) 72 to combine with second portion 74 of air supply 48 and second fuel 20B for combustion in secondary combustion zone 132.

Combustor 40 may also include valve 112 configured to, in an open position, flow additional portion 82 of air supply 48 to AFS injector(s) 72 through cooling passage 90. In a closed position, valve 112 blocks additional portion 82 of air supply 48 from flowing to cooling passage 90 and AFS injector(s) 72. Valve 112 may be operatively positioned between air supply 48 and AFS injector(s) 72. Each valve 112 is mounted in a valve opening 110. In certain embodiments, valve 112 can include a plurality of valves 112 circumferentially spaced around combustor body 44 to provide any desired volume, flow rate, etc., of additional portion 82 of air supply 48.

Valve(s) 112 can take a variety of forms. In certain embodiments, valve(s) 112 may include an electrically controlled valve controlled by a combustor controller (118, shown in FIG. 2) that controls operation of combustor 40. In other embodiments, valve(s) 112 may include a temperature sensitive control valve configured to close (or open) based on a temperature in combustor body 44, i.e., within the HGP. In yet other embodiments, valve(s) 112 may include a pressure sensitive control valve configured to close (or open) based on a pressure in combustor body 44. The temperature and/or pressure within combustor body 44 can be measured by any now known or later developed sensor(s) with access into combustor body 44. In other embodiments, valve(s) 112 may include a manually openable/closable valve having a manual control linkage accessible by a user, e.g., by extending through casing 46 for access by the user. While certain types of valves 112 have been listed herein, it will be recognized that where more than one valve 112 is used, the types used for each valve 112 can be different, e.g., an electric valve and manually operated valve. Any electric, temperature or pressure sensitive valve 112 can be operatively coupled to any combustor 40 controller (shown schematically as controller 118 in FIG. 2) and/or GT system 10 control system to control operation thereof. As the details of such control systems are known in the art outside of the methodology described herein, no further details are provided so the reader can focus on the salient parts of the disclosure.

As shown in FIG. 2, combustor 40 generally terminates at a point that is adjacent to a first stage 140 of stationary nozzles 142 of turbine 28. First stage 140 of stationary nozzles 142 at least partially defines a turbine inlet 144 to turbine 28. Combustor body 44, i.e., combustion liner 52, at least partially defines a hot gas path (HGP) for routing combustion gases 26 from primary combustion zone 130 and secondary combustion zone 132 to turbine inlet 144 of turbine 28 during operation of GT system 10.

A method of operating combustor 40 for GT system 10 will now be described. As noted, combustor 40 includes head end assembly 58 for first combusting a first fuel 20A in primary combustion zone 130 in combustor body 44 and AFS injector(s) 72 for selectively, second combusting a second fuel 20B in second combustion zone 132 in combustor body 44. In operation, compressed air 18 flows from compressor 16 to form air supply 48 and is then routed through various fluid flow passage(s). For example, second (post-cooling) portion 74 of air supply 48, i.e., compressed air 18, may be passed through cooling passage(s) 90, 102 in at least one hot part 84 of combustor 40 prior to delivering second portion 74 of air supply 48 to AFS injector(s) 72. First portion 62 of air supply 48, i.e., compressed air 18, is routed to head end assembly 58 of combustor 40 through air flow passage 60 where it reverses direction and is directed through axially extending fuel nozzle(s) 120. First portion 62 of air supply 48 is mixed with first fuel 20A to form a first combustible mixture that is injected into primary combustion zone 130. The first combustible mixture is burned to produce combustion gases 26.

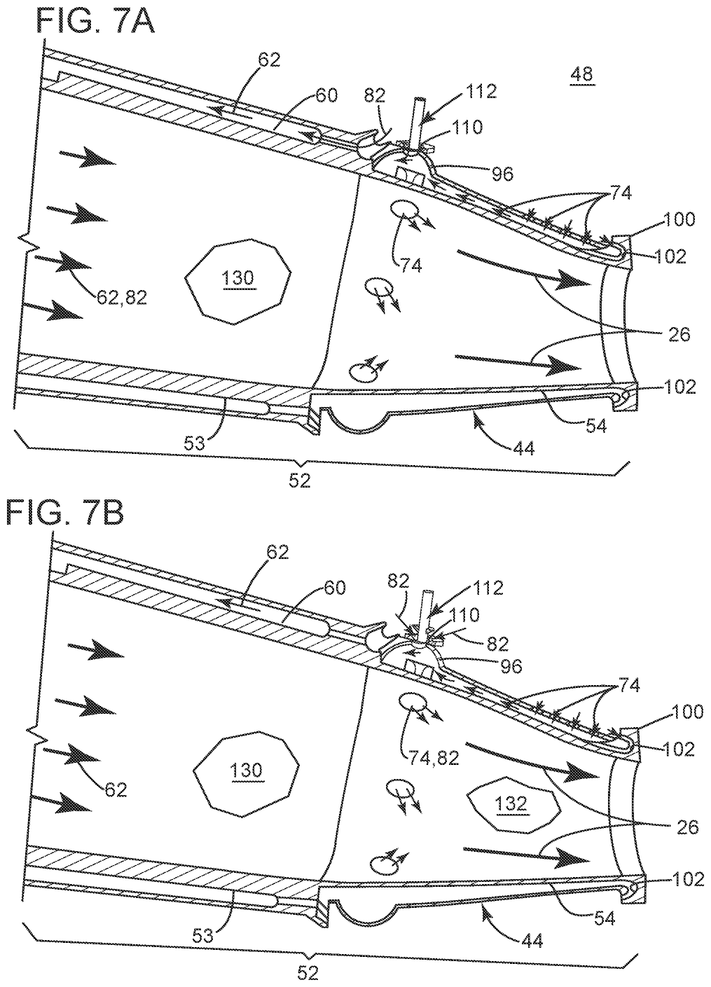

During certain settings, AFS injector(s) 72 may not be on, i.e., may be un-fueled and inoperative to introduce a fuel-air mixture to the secondary combustion zone 132. For example, during startup or shutdown or when certain highly reactive fuels are being used in head end assembly 58, AFS injectors 72 may be off. The terms “off” and “inactive,” as applied to AFS injectors 72, are intended to mean that the AFS injectors are un-fueled and do not supply a fuel-air mixture to the secondary combustion zone 132. In this setting, in response to AFS injector(s) 72 being inoperative, as shown in FIG. 7A, valve 112 is in a closed position. More particularly, in this setting, during a period in which the first combusting (from head end assembly 58) is occurring and the second combusting (from AFS injector(s) 72) is not occurring, first (pre-cooling) portion 62 of air supply 48 is delivered to head end assembly 58, second (post-cooling) portion 74 of air supply 48 is delivered to AFS injector(s) 72 (via cooling passage 90), and third, additional (pre-cooling) portion 82 of air supply 48 is delivered to head end assembly 58. In the closed position, valve 112 blocks third, additional portion 82 of air supply 48 (or any compressed air 18) from flowing directly to cooling passage 90 and AFS injector(s) 72, i.e., without going through any other cooling passages, which causes additional portion 82 of air supply 48 to enter air flow passage 60 to head end assembly 58.

Any openings in hot parts 84 that could otherwise receive additional portion 82, such as holes 98 in portion 94 of cooling passage 90 and/or other hot parts 84, are configured (e.g., dimensioned and/or shaped) to receive second portion 74 of air supply 48, i.e., compressed air 18, but additional portion 82 is redirected into air flow passage 60. Additional portion 82 of air supply 48 provides additional air to head end assembly 58 to increase air volume and velocity so higher reactive fuels (e.g., liquid fuels or hydrogen) can be used therein during this setting. The additional air also advantageously reduces the firing temperature of the head end assembly 58 (providing flame holding benefits) for highly reactive fuels. During this setting, second portion 74 of air supply 48 is sufficient to continue to cool hot part(s) 84 downstream of AFS injector(s) 72, relative to the flow of combustion gases 62, such as tapered transition portion 54 of combustion liner 52 or aft frame 100 at an aft end of tapered transition portion 54. In this setting, head end assembly 58 receives between 75 to 95% of air supply 48, and AFS injector(s) 72 receive between 5 to 25% of air supply 48. The second portion 74 of air supply 48 to the AFS injector(s) 72 is directed into the combustion chamber.

In another setting, combustor 40 is fully operational. More particularly, in this setting, during a period in which both the first combusting (from head end assembly 58) and the second combusting (from AFS injector(s) 72) occur, first (pre-cooling) portion 62 of air supply 48 is delivered to head end assembly 58, second (post-cooling) portion 74 of air supply 48 is delivered to cooling passage 90 and AFS injector(s) 72, and third, additional (pre-cooling) portion 82 of air supply 48 is delivered to AFS injector(s) 72 (perhaps through cooling passage 90). In response to AFS injector(s) 72 operating, i.e., being on and fueled, as shown in FIG. 7B, valve 112 is in an open position with additional portion 82 of air supply 48 flowing directly to AFS injector(s) 72. That is, valve 112 flows additional portion 82 of air supply 48 to AFS injector(s) 72. The delivery of additional (pre-cooling) portion 82 of air supply 48 thus includes controlling valve 112 operatively positioned between air supply 48 and AFS injector(s) 72.

Valve 112 may be controlled in any now known or later developed manner, e.g., using a combustor or GT system controller, or using manual operation. AFS injector(s) 72 may be turned on after a startup or change in fuel used in head end assembly 58 to provide additional kinetic energy to combustion gases 26 being delivered through combustion liner 52 to turbine 28. The terms “on” and “operational,” as applied to AFS injectors 72, are intended to mean that the AFS injectors are fueled and supply a fuel-air mixture to the secondary combustion zone 132. In this setting, additional portion 82 and second portion 74 of air supply 48 are mixed with second fuel 20B from fuel passages 150 (e.g., conduits from fuel supply 22 provided as external tubes or in combustor body 44 or in flow sleeve(s) 66) to form a second combustible mixture. Hence, during this setting with axial staged combustion, second portion 74 of air supply 48 is routed through any number of hot parts 84 before being routed to cooling passage 90 and radially extending AFS injector(s) 72 where it is routed into combustor body 44 with additional portion 82 of air supply 48 for use in combustion in primary combustion zone 130.

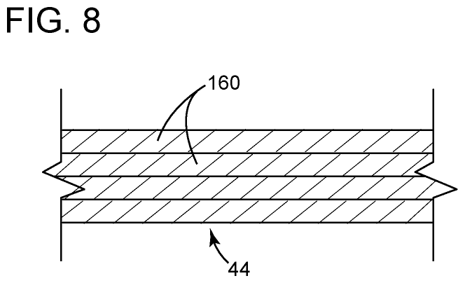

The second combustible mixture is injected through combustion liner 52 and into the hot gas path (HGP). The second combustible mixture at least partially mixes with combustion gases 26 and is burned in secondary combustion zone 132. Thus, when AFS injector(s) 72 are on, valve 112 opens to deliver additional air volume and velocity to the AFS injector(s) 72, i.e., during full operation of combustor 40. In this setting, head end assembly 58 may receive between 40 to 80% of air supply 48, and AFS injector(s) 72 may receive between 20 to 60% of air supply 48.

Where combustor body 44 is additively manufactured, there are no mechanical connections between the various parts (i.e., it is all one-piece). FIG. 8 shows a cross-sectional view of any portion of additively manufactured combustor body 44. As shown in FIG. 8, combustor body 44 includes a plurality of parallel, sintered metal layers 160, i.e., from the additive manufacturing thereof.

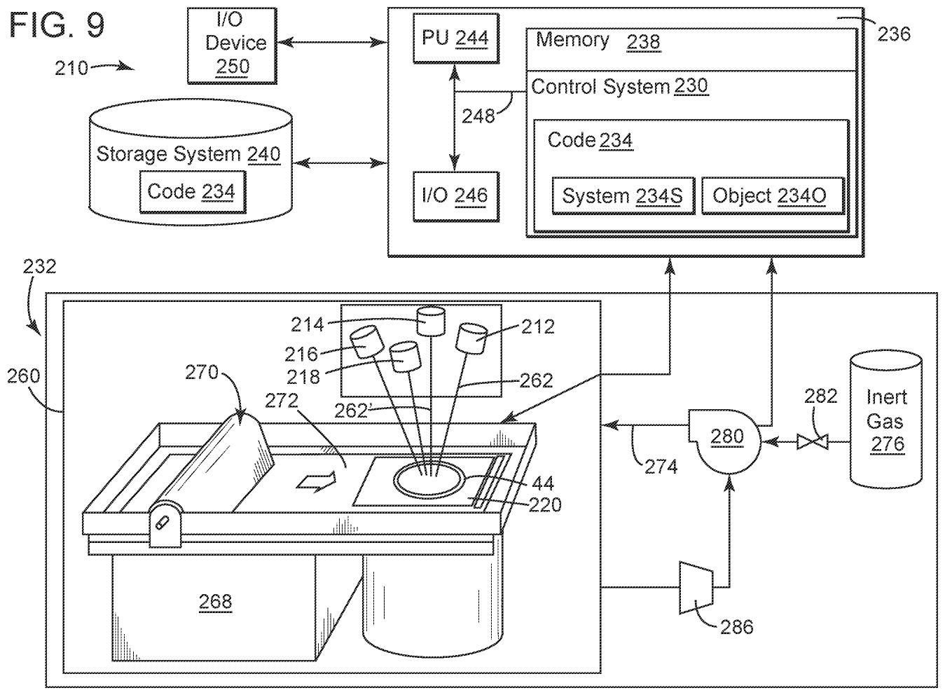

Combustor body 44 may be additively manufactured using any now known or later developed technique capable of forming the large, integral body. FIG. 9 shows a schematic/block view of an illustrative computerized metal powder additive manufacturing system 210 (hereinafter ‘AM system 210’) for generating combustor body 44, of which only a single layer is shown. The teachings of the disclosures will be described relative to building AM combustor body 44 using multiple melting beam sources 212, 214, 216, 218, but it is emphasized and will be readily recognized that the teachings of the disclosure are equally applicable to build AM combustor body 44 using any number of melting beam sources. In this example, AM system 210 is arranged for direct metal laser melting (DMLM). It is understood that the general teachings of the disclosure are equally applicable to other forms of metal powder additive manufacturing such as but not limited to selective laser melting (SLM), and perhaps other forms of additive manufacturing (i.e., other than metal powder applications). The layer of AM combustor body 44 in build platform 220 is illustrated in FIG. 9 as a circular element; however, it is understood that the additive manufacturing process can be readily adapted to manufacture any shaped part of AM combustor body 44 on build platform 220.

AM system 210 generally includes an additive manufacturing control system 230 (“control system”) and an AM printer 232. As will be described, control system 230 executes set of computer-executable instructions or code 234 to generate combustor body 44 using multiple melting beam sources 212, 214, 216, 218. In the example shown, four melting beam sources may include four lasers. However, the teachings of the disclosures are applicable to any melting beam source, e.g., an electron beam, laser, etc. Control system 230 is shown implemented on computer 236 as computer program code. To this extent, computer 236 is shown including a memory 238 and/or storage system 240, a processor unit (PU) 244, an input/output (I/O) interface 246, and a bus 248. Further, computer 236 is shown in communication with an external I/O device/resource 250. In general, processor unit (PU) 244 executes computer program code 234 that is stored in memory 238 and/or storage system 240. While executing computer program code 234, processor unit (PU) 244 can read and/or write data to/from memory 238, storage system 240, I/O device 250 and/or AM printer 232. Bus 248 provides a communication link between each of the components in computer 236, and I/O device 250 can comprise any device that enables a user to interact with computer 236 (e.g., keyboard, pointing device, display, etc.).

Computer 236 is only representative of various possible combinations of hardware and software. For example, processor unit (PU) 244 may comprise a single processing unit or may be distributed across one or more processing units in one or more locations, e.g., on a client and server. Similarly, memory 238 and/or storage system 240 may reside at one or more physical locations. Memory 238 and/or storage system 240 can comprise any combination of various types of non-transitory computer readable storage medium including magnetic media, optical media, random access memory (RAM), read only memory (ROM), etc. Computer 236 can comprise any type of computing device such as an industrial controller, a network server, a desktop computer, a laptop, a handheld device, etc.

As noted, AM system 210 and, in particular control system 230, executes code 234 to generate combustor body 44. Code 234 can include, among other things, a set of computer-executable instructions 234S (herein also referred to as ‘code 234S’) for operating AM printer 232, and a set of computer-executable instructions 2340 (herein also referred to as ‘code 2340’) defining AM combustor body 44 to be physically generated by AM printer 232. As described herein, additive manufacturing processes begin with a non-transitory computer readable storage medium (e.g., memory 238, storage system 240, etc.) storing code 234. Set of computer-executable instructions 234S for operating AM printer 232 may include any now known or later developed software code capable of operating AM printer 232.

The set of computer-executable instructions 2340 defining combustor body 44 may include a precisely defined 3D model of combustor body 44 and can be generated from any of a large variety of well-known computer aided design (CAD) software systems such as AutoCAD®, TurboCAD®, DesignCAD 3D Max, etc. In this regard, code 2340 can include any now known or later developed file format. Furthermore, code 2340 representative of combustor body 44 may be translated between different formats. For example, code 2340 may include Standard Tessellation Language (STL) files, which were created for stereolithography CAD programs of 3D Systems, or an additive manufacturing file (AMF), which is an American Society of Mechanical Engineers (ASME) standard that is an extensible markup-language (XML) based format designed to allow any CAD software to describe the shape and composition of any three-dimensional object to be fabricated on any AM printer. Code 2340 representative of combustor body 44 may also be converted into a set of data signals and transmitted, received as a set of data signals and converted to code, stored, etc., as necessary. Code 2340 may be configured according to embodiments of the disclosure to allow for formation of border and internal sections in overlapping field regions, as will be described. In any event, code 2340 may be an input to AM system 210 and may come from a part designer, an intellectual property (IP) provider, a design company, the operator or owner of AM system 210, or from other sources. In any event, control system 230 executes code 234S and 2340, dividing combustor body 44 into a series of thin slices that assembles using AM printer 232 in successive layers of material.

AM printer 232 may include a processing chamber 260 that is sealed to provide a controlled atmosphere for combustor body 44 printing. A build platform 220, upon which combustor body 44 is built, is positioned within processing chamber 260. A number of melting beam sources 212, 214, 216, 218 are configured to melt layers of metal powder on build platform 220 to generate combustor body 44. While four melting beam sources 212, 214, 216, 218 are illustrated, it is emphasized that the teachings of the disclosure are applicable to a system employing any number of sources, e.g., 1, 2, 3, or 5 or more. As understood in the field, each melting beam source 212, 214, 216, 218 may have a field including a non-overlapping field region, respectively, in which it can exclusively melt metal powder, and may include at least one overlapping field region in which two or more sources can melt metal powder. In this regard, each melting beam source 212, 214, 216, 218 may generate a melting beam, respectively, that fuses particles for each slice, as defined by code 2340.

For example, in FIG. 9, melting beam source 212 is shown creating a layer of combustor body 44 using melting beam 262 in one region, while melting beam source 214 is shown creating a layer of combustor body 44 using melting beam 262′ in another region. Each melting beam source 212, 214, 216, 218 is calibrated in any now known or later developed manner. That is, each melting beam source 212, 214, 216, 218 has had its laser or electron beam's anticipated position relative to build platform 220 correlated with its actual position in order to provide an individual position correction (not shown) to ensure its individual accuracy. In one embodiment, each of plurality melting beam sources 212, 214, 216, 218 may create melting beams, e.g., 262, 262′, having the same cross-sectional dimensions (e.g., shape and size in operation), power and scan speed.

Continuing with FIG. 9, an applicator (or re-coater blade) 270 may create a thin layer of raw material 272 spread out as the blank canvas from which each successive slice of the final combustor body 44 will be created. Various parts of AM printer 232 may move to accommodate the addition of each new layer, e.g., a build platform 220 may lower and/or chamber 260 and/or applicator 270 may rise after each layer. The process may use different raw materials in the form of fine-grain metal powder, a stock of which may be held in a chamber 268 accessible by applicator 270. In the instant case, combustor body 44 may be made of a metal which may include a pure metal or an alloy. In one example, the metal may include practically any non-reactive metal powder, i.e., non-explosive or non-conductive powder, such as but not limited to: a cobalt chromium molybdenum (CoCrMo) alloy, stainless steel, an austenite nickel-chromium based alloy such as a nickel-chromium-molybdenum-niobium alloy (NiCrMoNb) (e.g., Inconel 625 or Inconel 718), a nickel-chromium-iron-molybdenum alloy (NiCrFeMo) (e.g., Hastelloy® X available from Haynes International, Inc.), or a nickel-chromium-cobalt-molybdenum alloy (NiCrCoMo) (e.g., Haynes 282 available from Haynes International, Inc.). Other possibilities include, for example, René 52, CM 247, Mar M 247 and any precipitation harden-able (PH) nickel alloy.

Processing chamber 260 is filled with an inert gas such as argon or nitrogen and controlled to minimize or eliminate oxygen. Control system 230 is configured to control a flow of a gas mixture 274 within processing chamber 260 from a source of inert gas 276. In this case, control system 230 may control a pump 280, and/or a flow valve system 282 for inert gas to control the content of gas mixture 274. Flow valve system 282 may include one or more computer controllable valves, flow sensors, temperature sensors, pressure sensors, etc., capable of precisely controlling flow of the particular gas. Pump 280 may be provided with or without valve system 282. Where pump 280 is omitted, inert gas may simply enter a conduit or manifold prior to introduction to processing chamber 260. Source of inert gas 276 may take the form of any conventional source for the material contained therein, e.g., a tank, reservoir or other source. Any sensors (not shown) required to measure gas mixture 274 may be provided. Gas mixture 274 may be filtered using a filter 286 in a conventional manner.

In operation, build platform 220 with metal powder thereon is provided within processing chamber 260, and control system 230 controls flow of gas mixture 274 within processing chamber 260 from source of inert gas 276. Control system 230 also controls AM printer 232, and in particular, applicator 270 and melting beam sources 212, 214, 216, 218 to sequentially melt layers of metal powder on build platform 220 to generate combustor body 44 according to embodiments of the disclosure. While a particular AM system 210 has been described herein, it is emphasized that the teachings of the disclosure are not limited to any particular additive manufacturing system or method.

Once AM combustor body 44 is formed, as shown in FIG. 2, it may be assembled with other parts of combustor 40 and/or connected to turbine inlet 144. For example, head end assembly 58 may be coupled to forward end 138 of combustor body 44. Head end assembly 58 may be coupled in any now known or later developed fashion, such as welding or fasteners. In addition, coupling turbine inlet 144 may be coupled to aft frame 100. Aft frame 100 may be coupled to turbine inlet 144 in any now known or later developed fashion, such as welding or fasteners. Either end of the combustor body 104, 204 may be joined to other components using seals, in addition to or instead of fasteners or weld joints.

The disclosure provides various technical and commercial advantages, examples of which are discussed herein. As noted, the combustor body provides additional air where desired to improve a particular combustion process. When the AFS injector is off (i.e., unfueled), the valve provides additional air supply to the head end assembly to increase air volume and velocity so higher reactive fuels (e.g., liquid fuels or hydrogen) can be used therein. The additional air also advantageously reduces the firing temperature of the head end fuel nozzle assembly (providing flame holding benefits) for highly reactive fuels. When the AFS injector is on (i.e., fueled), the valve opens to deliver the additional air volume and velocity to the AFS injector(s), i.e., during full operation of the combustor.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise. “Approximately” or “about,” as applied to a particular value of a range, applies to both end values and, unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application of the technology and to enable others of ordinary skill in the art to understand the disclosure for contemplating various modifications of the present embodiments, which may be suited to the particular use contemplated.

1. A combustor for a gas turbine system, the combustor comprising:
a combustor body including a combustion liner including a cylindrical portion and a tapered transition portion;
a head end fuel nozzle assembly at a forward end of the combustor body;
an air flow passage defined at least partially by the combustor body, the air flow passage configured to deliver a first portion of an air supply to the head end fuel nozzle assembly;
an axial fuel stage (AFS) injector directed into the combustor body downstream of the head end fuel nozzle assembly;
a cooling passage at least partially defined by the tapered transition portion, the cooling passage configured to deliver a second portion of the air supply to the AFS injector; and
a valve operatively coupled to a curved portion of the cooling passage over the AFS injector and configured to, in an open position, flow a third, additional portion of the air supply to the AFS injector through the cooling passage and, in a closed position, block the third, additional portion of the air supply from flowing to the AFS injector.

2. The combustor of claim 1, wherein:
in response to the AFS injector operating, the valve is in the open position with the third, additional portion of the air supply flowing to the AFS injector; and
in response to the AFS injector being inoperative, the valve is in the closed position, blocking the third, additional portion of the air supply from flowing to the AFS injector and causing the third, additional portion of the air supply to enter the air flow passage to the head end fuel nozzle assembly.

3. The combustor of claim 1, wherein the air supply includes a compressor discharge, and wherein the first portion of the air supply is pulled directly from the compressor discharge and the second portion of the air supply passes through the cooling passage after being pulled from the compressor discharge, wherein the cooling passage is further defined in a hot part of the combustor.

4. The combustor of claim 3, wherein the hot part includes at least one of the tapered transition portion of the combustor body and an aft frame at an aft end of the tapered transition portion of the combustor body.

5. The combustor of claim 3, wherein the cooling passage is at least partially between the AFS injector and the air supply.

6. The combustor of claim 3, wherein the cooling passage is defined at least partially in the tapered transition portion of the combustor body or between the tapered transition portion of the combustor body and a flow sleeve spaced along at least a portion of an exterior surface of the tapered transition portion of the combustor body.

7. The combustor of claim 1, wherein the AFS injector includes a plurality of AFS injectors positioned about the combustor body, and the valve includes a plurality of valves.

8. The combustor of claim 1, wherein the valve includes one or more of: an electrically controlled valve controlled by a combustor controller that controls operation of the combustor, a temperature sensitive control valve configured to close based on a temperature in the combustor body, or a pressure sensitive control valve configured to close based on a pressure in the combustor body.

9. The combustor of claim 1, wherein the combustor body is additively manufactured (AM) and includes a plurality of parallel, sintered metal layers.

10. The combustor of claim 1, wherein the combustor body further includes:
an axial fuel stage (AFS) injector opening directed into the combustion liner downstream of the head end fuel nozzle assembly, the AFS injector opening configured to have the AFS injector mounted thereto and to receive the second portion of the air supply; and
a valve opening in fluid communication with the cooling passage, the valve opening configured to mount the valve;
wherein, in the open position of the valve, the third, additional portion of the air supply flows through the valve opening to the cooling passage and, in the closed position of the valve, the third, additional portion of the air supply is blocked from flowing to the cooling passage; and
wherein the air flow passage is defined at least partially by the cylindrical portion of the combustion liner.

11. A combustor body for a combustor for a gas turbine system, the combustor body comprising:
a combustion liner including a cylindrical portion and a tapered transition portion;
an air flow passage defined at least partially by the cylindrical portion of the combustion liner, the air flow passage configured to deliver a first portion of an air supply to a head end fuel nozzle assembly at a forward end of the combustion liner;
a cooling passage at least partially defined by the tapered transition portion;
an axial fuel stage (AFS) injector opening directed into the combustion body downstream of the head end fuel nozzle assembly, the AFS injector opening configured to have an AFS injector mounted thereto and to receive a second portion of the air supply through the cooling passage; and
a valve opening in fluid communication with the cooling passage, the valve opening being disposed on a curved portion of the cooling passage over the AFS injector and configured to mount a valve thereto.

12. A gas turbine (GT) system, comprising:
a compressor section;
a combustion section operatively coupled to the compressor section; and
a turbine section operatively coupled to the combustion section,
wherein the combustion section includes at least one combustor including:
a combustor body including a combustion liner including a cylindrical portion and a tapered transition portion;
a head end fuel nozzle assembly at a forward end of the combustor body;
an air flow passage defined at least partially by the combustor body, the air flow passage configured to deliver a first portion of an air supply to the head end fuel nozzle assembly;
an axial fuel stage (AFS) injector directed into the combustor body downstream of the head end fuel nozzle assembly;
a cooling passage at least partially defined by the tapered transition portion, the cooling passage configured to deliver a second portion of the air supply to the AFS injector; and
a valve operatively coupled to a curved portion of the cooling passage over the AFS injector and configured to, in an open position, flow a third, additional portion of the air supply to the AFS injector through the cooling passage and, in a closed position, block the third, additional portion of the air supply from flowing to the AFS injector.

13. The GT system of claim 12, wherein:
in response to the AFS injector operating, the valve is in the open position with the third, additional portion of the air supply flowing to the AFS injector; and
in response to the AFS injector being inoperative, the valve is in the closed position, blocking the third, additional portion of the air supply from flowing to the AFS injector and causing the third, additional portion of the air supply to enter the air flow passage to the head end fuel nozzle assembly.

14. The GT system of claim 12, wherein the air supply includes a compressor discharge of the compressor section, and wherein the first portion of the air supply is pulled directly from the compressor discharge and the second portion of the air supply passes through the cooling passage after being pulled from the compressor discharge, wherein the cooling passage is further defined in a hot part of the combustor.

15. The GT system of claim 14, wherein the cooling passage is at least partially between the AFS injector and the air supply.

16. The GT system of claim 14, wherein the cooling passage is defined at least partially in at least one of: the tapered transition portion of the combustor body or between the tapered transition portion of the combustor body and a flow sleeve spaced along at least a portion of an exterior surface of the tapered transition portion of the combustor body; or an aft frame at an aft end of the tapered transition portion.

17. The GT system of claim 12, wherein the combustor body includes:
an axial fuel stage (AFS) injector opening directed into the combustion liner downstream of the head end fuel nozzle assembly, the AFS injector opening configured to have the AFS injector mounted thereto and to receive the second portion of the air supply; and
a valve opening in fluid communication with the cooling passage, the valve opening configured to mount the valve;
wherein, in the open position of the valve, the third, additional portion of the air supply flows through the valve opening to the cooling passage and, in the closed position of the valve, the third, additional portion of the air supply is blocked from flowing to the cooling passage; and
wherein the air flow passage is defined at least partially by the cylindrical portion of the combustion liner.

18. A method of operating a combustor for a gas turbine system, the combustor including a head end fuel nozzle assembly for first combusting a first fuel in a primary combustion zone in a combustor body and an axial fuel stage (AFS) injector for selectively, second combusting a second fuel in a second combustion zone in the combustor body, the method comprising:
in a first setting, during a period in which both the first combusting and the second combusting occur, delivering a first portion of an air supply to the head end fuel nozzle assembly, a second portion of the air supply to the AFS injector, and a third, additional portion of the air supply to the AFS injector; and
in a second setting, during a period in which the first combusting is occurring and the second combusting is not occurring, delivering the first portion of the air supply to the head end fuel nozzle assembly, the second portion of the air supply to the AFS injector, and the third, additional portion of the air supply to the head end fuel nozzle assembly,
wherein the delivering of the third, additional portion of the air supply includes controlling a valve operatively coupled to a curved portion of the cooling passage over the AFS injector.

19. (canceled)

20. The method of claim 18, wherein, in the first setting, the head end fuel nozzle assembly receives between 40 to 80% of the air supply, and the AFS injector receives between 20 to 60% of the air supply; and wherein, in the second setting, the head end fuel nozzle assembly receives between 75 to 95% of the air supply, and the AFS injector receives between 5 to 25% of the air supply.

21. The method of claim 18, further comprising passing the second, portion of the air supply through a cooling passage in at least one hot part of the combustor prior to delivering the second, portion of the air supply to the AFS injector.
